(19) United States
(12) Patent Application Publication
(10) Pub. No.: US 2008/0303961 A1
(43) Pub. Date: Dec. 11, 2008

(54) Inputs switching device

(75) Inventor: Tomonori Shioji, Osaka (JP)

Correspondence Address: Yokoi & Co.;U.S.A., Inc., #723, 13700 Marina Pointe Drive, Marina Del Rey, CA, 90292, US

(73) Assignee: Funai Electric Co., Ltd., Osaka (JP)

(21) Appl. No.: 12/156,344

(22) Filed: May 30, 2008

(30) Foreign Application Priority Data
Jun. 5, 2007 (JP) JP2007-149025

(51) Int. Cl. H04N 5/44

(52) U.S. Cl. 348/734

(57) ABSTRACT

The present invention discloses an inputs switching device, includes: a plurality of external inputs accepting unit to accept different external inputs; a switching order storage unit to store a switching order of the external inputs to be output; an external inputs switching unit to switch the external inputs to be output sequentially as set forth within the stored switching order in response to a pressing of an operation key; and a non-switching unit to make the external inputs switching unit not to switch a specified external input that is specified from the external inputs of the switching order.

### CROSS-REFERENCES TO RELATED APPLICATIONS

The present application is related to the Japanese Patent Application No. 2007-149025, filed Jun. 5, 2007, the entire disclosure of which is expressly incorporated by reference herein.

### BACKGROUND OF THE INVENTION

(1) Field of the Invention

The present invention relates to an inputs switching device capable of switching a plurality of external inputs, and more specifically to an inputs switching device capable of switching external inputs by simple operation of an operation key.

(2) Description of the Related Art

An inputs switching device is a device to switch inputs from a plurality of external inputs connected thereto and output them. The inputs switching device is, for example, mounted in a television receiver and switches the signals input from external apparatuses to output them selectively. The inputs switching device includes: an interface that accepts external inputs; a switching means that switches the external inputs entered through the interface; and a storage means that stores the switching order for external inputs. In such an inputs switching device, the switching means switches external inputs sequentially based on the switching order stored in the storage means in response to the pressing of an operation key such as a remote control. Therefore, if a user desires to select a low-order external input stored in the storage means, the user needs to go on pressing the operation key until the desired external input is selected. Because of this, when multiple external inputs exists, it takes time for the user to switch to the desired external input.

To solve the above problem, there is disclosed a technology wherein different switching orders (toggle group) are stored in advance in the storage means and the user selects a particular toggle group from among multiple toggle groups (refer to patent document 1: JP-A No. 8-321997).

With this technology, it is possible for the user to set external inputs that corresponds to the pressing of the switching key by selecting a desired toggle group from among multiple toggle groups.

Also, to overcome the same problem, there is disclosed another technology wherein the priority of accepting external inputs is set in advance and external inputs are switched according to the set priority (refer to patent document 2: JP-A No. 5-102002).

With such a technology, it is possible to set external switching order according to the user's preference.

However, the patent documents 1 and 2 have the following problems. That is, it is difficult to set external inputs according to the frequency of use and/or preference of the user. Accordingly, an inputs switching device has been desired that allows the decrease in the number of operations of an operation key when selecting external inputs, by enabling even a user unfamiliar with the setting operation to set easily and also to set external inputs according to the frequency of use and/or preference of the user.

### BRIEF SUMMARY OF THE INVENTION

One embodiment of the present invention discloses inputs switching device, includes: a plurality of external inputs accepting unit to accept different external inputs; a switching order storage unit to store a switching order of the external inputs to be output; an external inputs switching unit to switch the external inputs to be output sequentially as set forth within the stored switching order in response to a pressing of an operation key; and a non-switching unit to make the external inputs switching unit not to switch a specified external input that is specified from the external inputs of the switching order.

These and other features, aspects, and advantages of invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and the drawings are to be used not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

FIG. 1 is a block diagram showing a television receiver;

FIG. 2 is a conceptual drawing showing the switching of external inputs;

FIG. 3 is a flowchart showing a stored external inputs switching program;

FIG. 4 is an exemplary history table;

FIG. 5 is a flowchart showing a stored history update program; and

FIG. 6 is an exemplary history table.

### DETAILED DESCRIPTION OF THE INVENTION

One embodiment of the present invention will be described in the order as follows:

A. First embodiment

B. Modified example

Some embodiments of the present invention will be described below in the following order:
A. Configuration of a television receiver
B. Embodiment 1
C. Embodiment 2
D. Various modifications
E. Conclusion

### A. Configuration of a Television Receiver

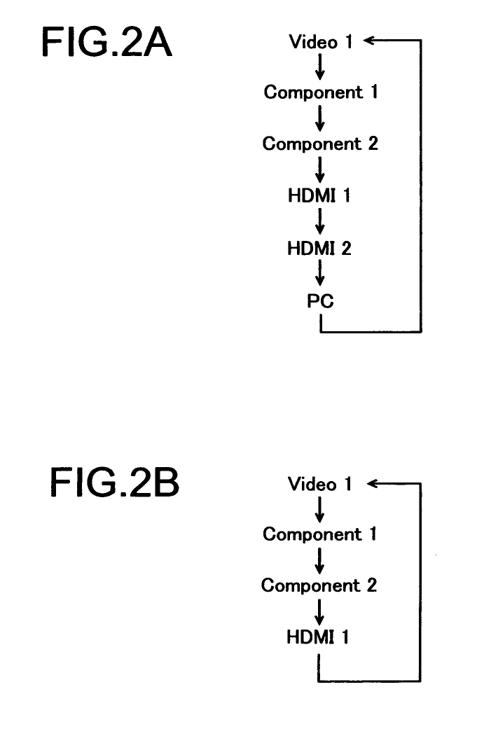

A television receiver according to the present invention can accept signals to be output from different external inputs via a plurality of input terminals (external inputs accepting means). These plurality of input terminals are switched sequentially by a control unit (external inputs switching means or non-switching means) according to the preset switching order by pressing the operation key on a remote control or an operation panel, as shown in FIG. 2(a). Here, the control unit switches external inputs sequentially according to a stored database (switching order storage means). Also, the control unit can specify an external input not to be switched by pressing the operation key by referring to various histories stored in the database (history storage means). This allows the television receiver according to the present invention to switch only external inputs with high priority set by the user by pressing the operation key continuously.

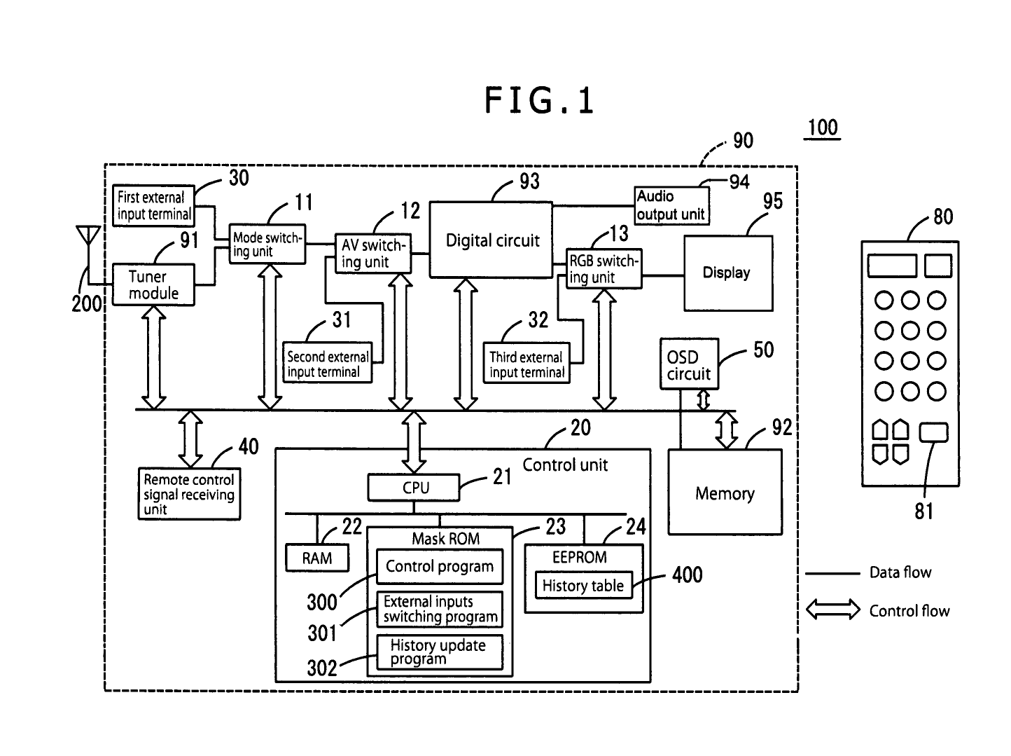

As shown in FIG. 1, the television receiver 100 is composed of a receiver 90 and a remote control 80. The receiver 90 includes: a tuner module 91 that receives a required frequency band from television broadcast signals received by an antenna 200 and extracts a video signal and an audio signal; a memory 92 that stores temporarily the extracted video signal; a control unit 20 that controls the drive of the television receiver 100; a digital circuit 93 that executes predetermined signal processing on the video signal stored in the memory 92; an audio output unit 94 that outputs sound; a display 95 that displays an image; input terminals 30, 31, and 32 that accept external inputs from respective external apparatuses; a switching units 11, 12, and 13 that switch inputs; a remote control signal receiver 40 that accepts the operation from the remote control 80; and an OSD circuit 50 that overlays a menu screen on the video signal.

In the television receiver 100, when a desired channel is selected by operating the remote control 80, the remote control signal receiver 40 receives a control signal corresponding to the selected channel. Then, the remote control signal receiver 40 outputs the control signal to the control unit 20 to instruct the tuner module to detect a frequency band corresponding to the selected channel. The tuner module 91 decodes the detected television broadcast signal to extract a video signal and an audio signal. The extracted video signal is stored temporarily in the memory 92 and undergoes the predetermined signal processing through the digital circuit 93. Then, the video signal is output to the display 95 and the audio signal is output to the audio output unit 94. When an external inputs switching key 81 of the remote control 80 is pressed, the control unit 20 switches the switching units 11, 12, and 13 according to the order stored beforehand to switch signals input from external apparatuses. Furthermore, the television receiver 100 can display the menu screen on the screen by overlaying OSD data stored in the OSD circuit 50 on the video signal stored in the memory 92.

The television receiver 100 has a plurality of input terminals. By way of example, the television receiver 100 according to the present invention includes: a first external input terminal 30 that accepts video and audio inputs from a reproducing apparatus or the like; a second external input terminal 31 that accepts the connection from an external apparatus capable of connecting to a 21-pin multiconnector; and a third external input terminal 32 that can be connected to an external apparatus such as a personal computer capable of connecting to an 8-pin connector. The first input terminal 30 and the output terminal of the tuner module are connected to a mode switching unit 11 respectively. Likewise, the second external input terminal 31 and the mode switching unit 11 are connected to an AV switching unit 12, and the third external input terminal 32 and the output of the AV switching unit 12 are connected to an RGB switching unit 13. Thus, each switching unit performs the switching of input signals under control of the control unit 20.

The control unit 20 controls the drive of the television receiver 100. The control unit 20 includes: a CPU 21 that serves as a core arithmetic function; a mask ROM 23 wherein various programs are stored; an EEPROM 24 wherein a rewritable database is stored; and a RAM 22 where the CPU 21 deploys a database as well as a program. The mask ROM 23 contains a control program 300 to control the drive of the television receiver 100, an external inputs switching program 301 to instruct each switching unit to switch external input terminals, and a history update program 302 to update a database. The EEPROM 24 contains a history table 400 by which the CPU 21 refers to the switching order of external inputs.

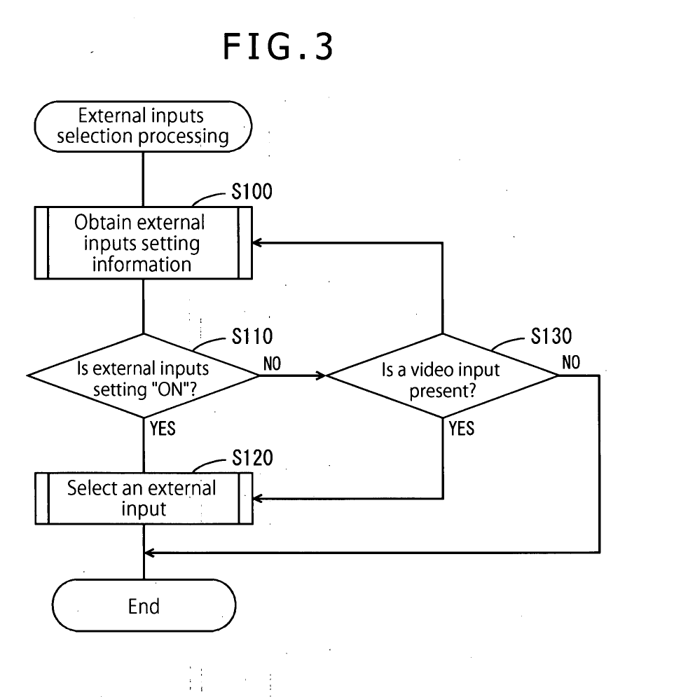

FIG. 3 is a flowchart showing the external inputs switching program 301 stored in the mask ROM 23. When an external inputs switching key 81 is pressed, the control unit 200 reads the external inputs switching program 301 stored in the mask ROM 23 to deploy it on the RAM 22. The external inputs switching program 301 is a program that causes the CPU 21 to switch external inputs to respective switching units in response to the pressing of the external inputs switching key 81. The CPU 21 then refers to a database stored in the EEPROM 24 (step S100). At this time, the CPU 21 judges whether or not each external input can be selected on the database (step S110). As an example of the judgment, when a flag indicating that an external input is to be switched on the database is “1”, that external input is to be switched. Furthermore, the CPU 21 issues a switching command to each external inputs switching unit while referring to the database (step S120). This causes each external inputs switching unit to switch signals to be output.

The order in which the CPU 21 switches external inputs at step S120 is as follows. The television receiver 100 is capable of accepting as an external input, for example, VIDEO 1, VIDEO 2, Component 1, Component 2, HDMI 1, HDMI 2, and PC. Therefore, to cause the television receiver 100 to display the VIDEO 1 and VIDEO 2, the CPU 21 controls the mode switching unit 11 to switch the tuner module 91 to the first external input terminal 30. Also, to select the Component 1, Component 2, the CPU 21 controls the mode switching unit 11 and the AV switching unit 12 to cause a signal from the second external input terminal 31 to be input. To select the HDMI 1, HDMI 2, and PC, the CPU 21 controls the RGB switching unit 13 to cause a signal from the third external input terminal 32 to be input.

If an external input cannot be selected on the database, the CPU 21 determines if a video signal or an audio signal has been input from that external input (step S130). At this time, whether a video signal or an audio signal is output from the external input terminal may be determined by detecting a control signal to be input from an external apparatus via each external input terminal or by directly detecting a video signal or an audio signal. This constitutes a specific signal switching means of the control unit 20.

### B. Embodiment 1

An embodiment using the television receiver 100 will be described below. In this embodiment, the user sets in advance external inputs to be selected by pressing the external inputs switching key 81. Accordingly, when the user operates the external inputs switching key 81, only the preset external input is selected in response to the pressing of each key This displays the selected external input on the screen.

The television receiver 100 is, as shown in FIG. 2(a), capable of switching external inputs: VIDEO 1, VIDEO 2, Component 1, Component 2, HDMI 1, HDMI 12, and PC. In order to switch to VIDEO 1, VIDEO 2, Component 1, Component 2, and HDMI 1 in this order as shown in FIG. 2(b), the user sets the television receiver 100 using the following procedure. First, the user displays a menu screen on the screen of the receiver 90 by operating, for example, the remote control 80. Then on the menu screen, the user displays a screen based on the database stored in the EEPROM 24, and selects on that screen the external inputs to be switched. At this time, it is possible to select external inputs not to be switched. Thereafter, when a decision key is pressed, the CPU 21 rewrites the actual database stored in the EEPROM 24 by referring to the database updated on the screen. Then, the external inputs switching key 81 is pressed sequentially, the CPU 21 instructs the switching of external inputs according to the external inputs switching program 301 shown in FIG. 3. This causes the external inputs to be switched in the order shown in FIG. 2(b) each time the external inputs switching key 81 is pressed.

### C. Embodiment 2

Another embodiment using the television receiver 100 will be described below. In this embodiment, the database the CPU 21 refers to is automatically updated each time an external input is used. The database history to be updated is, for example, the frequency of use or operating time of an external input. Based on the updated database, the CPU 21 changes an external input to be switched. Thereafter, when the external inputs switching key 81 is pressed, the CPU 21 switches external inputs based on the updated database.

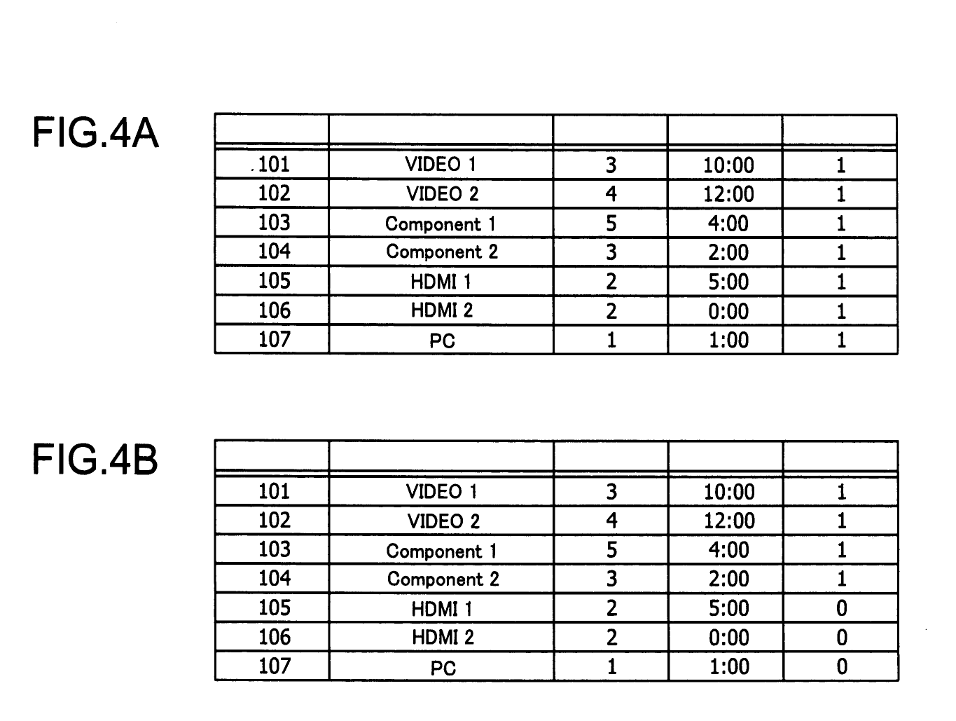

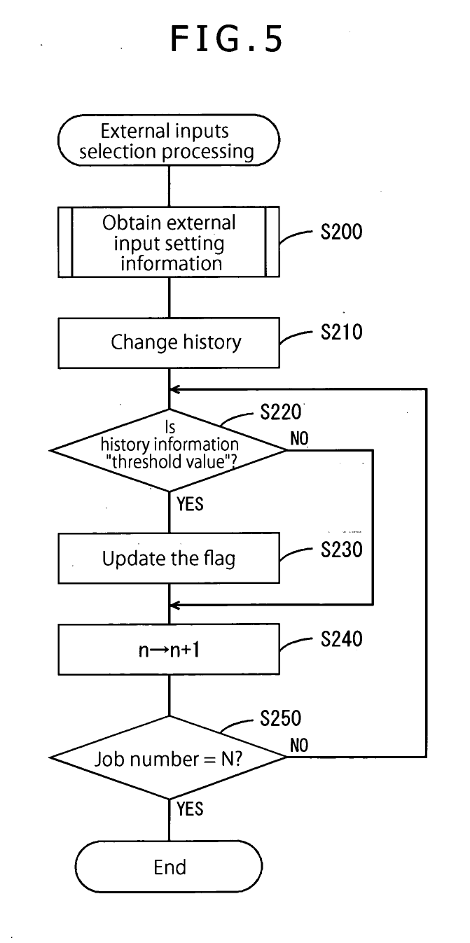

In the EEPROM 24 according to the present invention, a history table as shown in FIG. 4 is stored. The history table contains code numbers indicating the order of selection of external inputs, the name of respective external inputs, and the selection frequency and execution time of an external input as the history information to be updated. When an external input is selected, the CPU 21 updates the history table according to the history update program shown in FIG. 5. Here, the selection frequency of each external input indicates how often each external input has been selected. The frequency is counted based on the number of control signals to be output from an external apparatus and video and/or audio signals to be input. The execution time of an external input indicates how many hours each external input has been used. The execution time is counted based on the input time of a control signal and a video and/or audio signal.

When a signal is input from an external apparatus connected to the selected external input terminal, the CPU 21 updates the history items of the history table 400. Specifically, when a signal is output from an external apparatus via each external input terminal, the CPU 21 reads the history update program 302 stored on the ROM 23 to deploy it on the RAM 22. Then, the CPU 21 refers to the history table 400 stored on the EEPROM 24 (step S200) to update each item of the history information (step S210). Next, the CPU 21 compares each item of the history information of the history table 400 with predetermined threshold values (step S220). To be specific, if the history information the CPU 21 refers to is the frequency of use of an external input, the CPU 21 compares the threshold value “Tm” indicating the predetermined frequency with the history information indicating the frequency of use. At this time, if the history information is less than the threshold value Tm, then the CPU 21 updates the flag stored in the history table to eliminate the corresponding external input from the external inputs to be switched. Of course, if that external input has been set to be unswitchable, the flag is not changed. Also, if the history information is larger than the threshold value Tm, the CPU 21 does not change the flag (step S220). Thereafter, the CPU 21 increments the job count “n” stored in an internal counter by one (step S240). Furthermore, the CPU 21 compares the job count n in the internal counter with the total job count “N” (step S250). If the internal counter value “n” is less than the total job count N, then the CPU 21 returns to step S220 to repeat the same processing. Then, when the internal counter value n reaches the total job count N, the CPU 21 ends the processing.

After the history table described above is updated, when the user presses the switching key 81 continuously, external inputs are switched on the screen of the television receiver 100 based on the automatically updated history table. Here, if the threshold value Tm is 20, the HDMI1 and HDMI2 are eliminated from the switchable external apparatuses listed in the history table shown in FIG. 4, and only the VIDEO 1, VIDEO 2, Component 1, and Component 2 become the switchable external apparatuses. Therefore, when the user presses the external inputs switching key 81 continuously, external inputs will be displayed in the order: VIDEO 1, VIDEO 2, Component 1, and Component 2. This allows only the frequently used external inputs to be switched, and also makes it unnecessary for the user to set switchable external inputs and thereby get off troublesome setting operation.

### D. Various Modifications

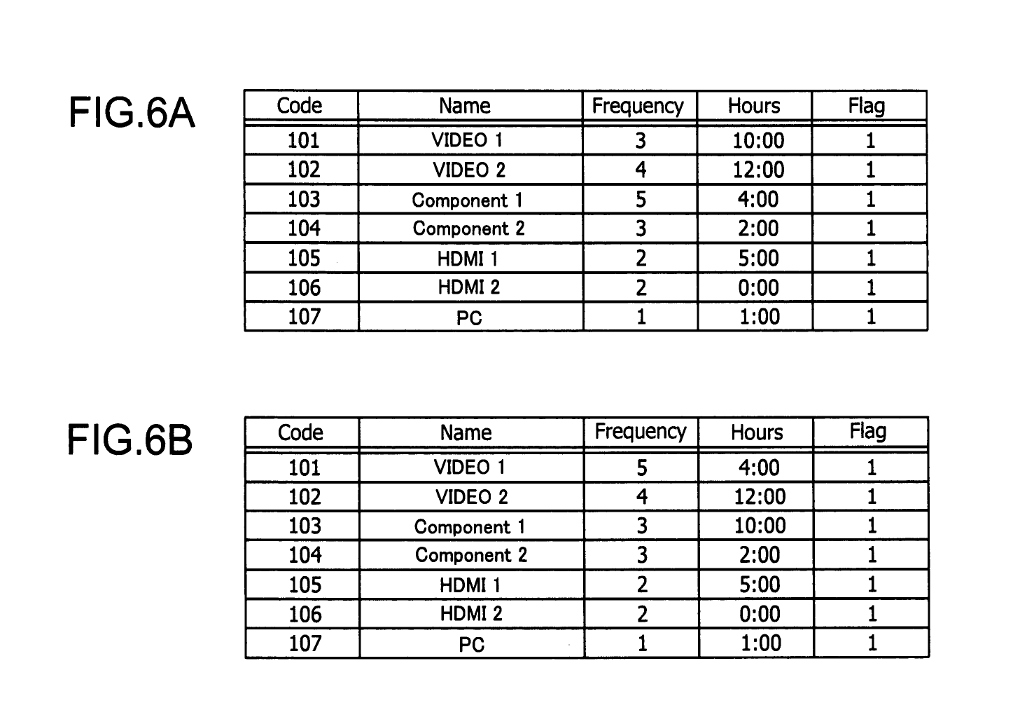

The television receiver 100 according to the present invention allows various modifications. When the history table is automatically updated as described above, the external inputs may be reordered based on the history information. As shown in FIG. 6, in this modification, the external inputs stored in the history table are reordered according to the descending order of frequency of use. Then, when the external inputs switching key 81 is pressed continuously, the CPU 21 switches the external inputs according to the changed order. As a result, it is possible to make the switching order of the external inputs correspond to the frequency of use. Also, by combining this modification and the technology of the embodiment 2, it is possible for the user to select only the external inputs according to the frequency of use. Of course, this will reduce the number of times the external inputs switching key is pressed.

### E. Conclusion

The television receiver according to the present invention can accept data to be output from different external inputs via a plurality of external input terminals (external input accepting means). The plurality of external input terminals are switched sequentially according to the switching order set in advance by the control unit by pressing the operation key on a remote control or an operation panel. Here, the control unit switches external inputs sequentially according to the stored database. Also, the control unit can specify the unswitchable external inputs by referring to various histories stored in the database and pressing the operation key. This allows the television receiver of the present invention to switch only frequently used external inputs by pressing the operation key continuously.

In the configuration of the present invention, external inputs specified by the non-switching means are not to be switched by the external inputs switching means. Therefore, if some external inputs have been set to be unswitchable by the user, the other external inputs are selected, skipping the preset external inputs, when the operation key is pressed. Accordingly, even if the user is not familiar with the setting operation, the setting can be made simply by presetting the external inputs not to be switched. This allows the user to set external inputs according to the frequency of use or user's preference. Also, because only the desired external inputs are selected after the setting, a switching operation can be performed easily simply by pressing the operation key.

Here, the external inputs specified as unswitchable by the non-switching means cannot be selected by continuous pressing of the operation key. This problem can be overcome by switching such external inputs based on the identification signal output from those external inputs when signals from unswitchable external inputs need to be output. Therefore, the present invention may be configured to have a specific signal switching means that, when an identification signal indicating the characteristic of an external input is received from an external input specified by the non-switching means, issues an instruction to the external inputs switching means to switch to the specified external input.

In this configuration, it is possible to output even an external input specified by the non-switching means by using other means than those associated with operation of the operation key. Here, the identification signal is a signal that identifies the type of an external input. The control signal to be output from an external apparatus is an example thereof.

Also, how to set external inputs by the non-switching means is not limited to manual setting but may be such method that a setting condition is predetermined, and when that setting condition is satisfied, desired external inputs are automatically eliminated from those to be switched. Therefore, the present invention is configured to include: a switching history storage means to store the switching history of external inputs switched by the external inputs switching means; and a switching order update means to update the switching order of the external inputs stored in the switching order storage means based on the switching history, and the external inputs specified by the non-switching means.

Here, the updating of operation history means the rearrangement of the switching order and the specification of unswitchable external inputs by the non-switching means. Thanks to this configuration, frequently switched external inputs are automatically set to higher ordered ones, and thus the user needs not to set the switching of external inputs.

Also, various switching types can be assumed as those to be referred to. Therefore, the present invention may be configured such that the switching history to be stored in the switching history storage means is the number of times external inputs were switched.

In this configuration, since external inputs are specified by the non-switching means as well as the switching means based on the number of times external inputs were switched, it is possible to set the priority of external inputs according to the frequency of use.

Furthermore, the switching history to be stored in the switching history storage means may be the accumulated execution time of an external input. This allows the setting of priority according to the accumulated execution time.

Also, the present invention is adaptable to any apparatus having an inputs switching device. Therefore, the inputs switching device of the present invention may be configured such that it is mounted in a television receiver; the switching order storage means is a database to be stored in a nonvolatile recording medium; the external inputs switching means and the non-switching means are implemented by a control unit including a CPU; the database stores the switching history of external inputs as well as flags indicating whether or not respective external inputs are to be switched; and the control unit updates the switching order of the external inputs stored in the database and the flags based on the stored switching history, and also issues, when an identification signal indicating the characteristic of the external input is received from an external input that is specified as unswitchable on the database, an instruction to the control unit to switch to the specified external input.

According to the present invention, it is possible to switch to and output even an external input specified by the non-switching means by means not associated with the operation of the operation key. Also, the present invention makes it unnecessary for the user to set the switching of external inputs. The present invention allows the setting of the priority of external inputs according to the frequency of use. Furthermore, the present invention allows the setting of priority according to the accumulated execution time.

Although the invention has been described in considerable detail in language specific to structural features or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It is to be understood that the phraseology and terminology employed herein, as well as the abstract, are for the purpose of description and should not be regarded as limiting.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. An inputs switching device, comprising:
a plurality of external inputs accepting unit to accept different external inputs;
a switching order storage unit to store a switching order of the external inputs to be output;
an external inputs switching unit to switch the external inputs to be output sequentially as set forth within the stored switching order in response to a pressing of an operation key; and
a non-switching unit to make the external inputs switching unit not to switch a specified external input that is specified from the external inputs of the switching order.

2. An inputs switching device as set forth claim 1, further comprising:
a specific signal switching unit that issues an instruction to the external inputs switching unit to switch to the specified external input when an identification signal indicating the characteristic of the external input is received from an external input specified by the non-switching unit.

3. An inputs switching device as set forth claim 1, further comprising:
a switching history storage unit to store the switching history of external inputs switched by the external inputs switching unit; and
a switching order update unit to update the switching order of the external inputs stored in the switching order storage unit based on the stored switching history, and the external inputs specified by the non-switching unit.

4. An inputs switching device as set forth claim 3, wherein:
the switching history stored in the switching history storage unit is the number of times external inputs were switched.

5. An inputs switching device as set forth claim 3, wherein:
the switching history stored in the switching history storage unit is the accumulated execution time of external inputs.

6. An inputs switching device as set forth claim 1, comprising:
the inputs switching device is mounted in a television receiver;
the switching order storage unit is a database to be stored on a nonvolatile recording medium;
the external inputs switching unit and the non-switching unit are implemented by a control unit having a CPU;
the database stores the switching history of external inputs and also stores flags indicating whether or not respective external inputs are to be switched;
the control unit updates the switching order of external inputs stored in the database and the flags, based on the stored switching history; and
when an identification signal indicating the characteristic of an external input is received from an external input specified as unswitchable on the database, the control unit issues an instruction to switch to the specified external input.
